(19) United States
(12) Patent Application Publication
(10) Pub. No.: US 2004/0108307 A1
(43) Pub. Date: Jun. 10, 2004

(54) Ceramic cooktop

(76) Inventors: Rainer Gadow, Aschau am Inn (DE); Andreas Killinger, Filderstadt-Bernhausen (DE); Christian Friedrich, Muenchen (DE); Chuanfei Li, Stuttgart (DE); Karsten Wermbter, Budenheim (DE)

Correspondence Address: HARNESS, DICKEY & PIERCE, P.L.C., P.O. BOX 828, BLOOMFIELD HILLS, MI, 48303, US

(21) Appl. No.: 10/649,177

(22) Filed: Aug. 27, 2003

Related U.S. Application Data
(63) Continuation of application No. PCT/EP02/01742, filed on Feb. 19, 2002.

(30) Foreign Application Priority Data
Mar. 6, 2001 (DE) 101 12 236.5

(51) Int. Cl. H05B 3/68

(52) U.S. Cl. 219/468.1

(57) ABSTRACT

The invention discloses a ceramic cooktop comprising a cooking plate made of a glass ceramic or glass. The ceramic cooktop also comprises an electrical heat conductor layer and an insulating layer that is located between the cooking plate and the heat conductor layer. Onto the cooking plate a thermally sprayed bonding layer is applied, before further layers are applied.

### RELATED APPLICATIONS

This is a continuation application of copending International patent application PCT/EP02/01742 filed on Feb. 19, 2002 and designating the United States which was not published in English under PCT Article 21 (2), and claiming priority of German patent application DE 101 12 236.5 filed on Mar. 06, 2001. Additional copending applications are PCT/EPO2/01743 and PCT/EPO2/01751.

### BACKGROUND OF THE INVENTION

The invention relates to a ceramic cooktop comprising a cooking plate of glass ceramic or glass, an electric heat conductor layer and a thermally sprayed,insulating layer between the cooking plate and the heat conductor layer.

Such a ceramic cooktop is for instance known from DE 05 065 C2 or from U.S. Pat. No. 6,037,572. The known ceramic cooktop comprises a cooking plate of a glass ceramic, the lower surface of which is supplied with a thermally sprayed grounded metal layer onto which a ceramic insulating layer is sprayed, onto the lower surface of which finally a heat conductor layer comprising a heat conductor element is e.g. applied by a screen printing process.

When compared with prior art ceramic cooktops which up to now basically were heated by irradiation of heat conductors arranged below and at a distance from the glass ceramic plate, such a cooktop offers a considerably improved initial cooking power, since the heat is now conducted by heat conducting and is generated directly on the lower surface of the glass ceramic. Since a glass ceramic suitable for a cooktop, such as CERAN® of Schott comprises an NTC-characteristic, i.e. with rising temperature also the electric conductivity raises considerably, there is a ceramic insulating layer between the heat conductor layer and the cooking plate.

A particular problem of such a ceramic cooktop rests in the different coefficients of thermal expansion of the individual layers. It is known that a glass ceramic such as CERAN® has a coefficient of expansion α which is close to 0 (±0.15×10⁻⁶ K⁻¹). By contrast, metals have a considerably higher coefficient of expansion which is considerably above 10⁻⁵ K⁻¹. Although ceramics have a lower coefficient of expansion (e.g. 8×10⁻⁶ K⁻¹ for Al₂O₃), also, when employing thicker layers, this leads to considerable problems resulting from thermal stresses during operation.

To guarantee the necessary operating safety according to VDE, the breakdown resistance of the insulating layer must be 3,750 Volts during cooking operation.

This requires a relatively large layer thickness of the ceramic insulating layer which must be about 300 μm or higher for aluminum oxide.

However, such a thick ceramic insulating layer cannot easily be applied by thermal spraying onto a glass ceramic surface, since herein usually fractures are noticed or delamination occurs.

However, if, as known from DE 31 05 065 C2, an electrically conductive grounded intermediate layer is employed between the insulating layer and the cooking plate of glass ceramic, then due to the grounding only a breakdown resistance of about 1,500 Volts is necessary, whereby the thickness of the insulating layer can be reduced accordingly. However, the application of a metal layer between the insulating layer and the glass ceramic plate introduces further problems due to the high coefficient of thermal expansion of the metal layer.

### SUMMARY OF THE INVENTION

Thus it is a first object of the invention to disclose a ceramic cooktop having an improved operating safety.

It is a second object of the invention to disclose a ceramic cooktop having a good long term stability in rough daily operation.

It is a forth object of the invention to disclose a ceramic cooktop having a good electric breakdown resistance of the insulating layer.

It is a fifth object of the invention to disclose a ceramic cooktop that is easy to produce in a cost-effective way.

It is a sixth object of the invention to disclose a method of producing such a ceramic cooktop.

These and other objects are solved according to the invention by providing on the cooking plate a thermally sprayed bonding layer consisting of a ceramic material.

The object of the invention is solved completely in this way. Namely, according to the invention it is made possible to apply, instead of aluminum oxide, better suited materials for the generation of the insulating layer by thermal spraying onto the glass ceramic cooking plate. In particular, it is possible to utilize an insulating layer having a coefficient of thermal expansion that allows a better matching of the coefficient of thermal expansion to that of the cooking plate.

Namely, according to the invention this insulating layer may now consist of cordierite, of mullite or mixtures thereof or of other thermally sprayable ceramics with a similar low coefficient of thermal expansion.

When thermally spraying these materials directly onto the surface of a glass ceramic, the latter is damaged. Thus when thermally spraying cordierite or mullite onto the glass ceramic surface, microfractures result which impair the stability of the overall system.

Cordierite and mullite have a coefficient of thermal expansion which is considerably lower than the coefficient of thermal expansion of aluminum oxide. While the coefficient of thermal expansion is about 2.2 to 2.4×10⁻⁶ K⁻¹ for cordierite, the coefficient of thermal expansion of mullite is about 4.3 to 5.0×10⁻⁶ K⁻¹. Thus by utilizing these materials the problem of thermally induced stresses during operation can be considerably reduced due to the low coefficient of thermal expansion.

In particular, a layer of aluminum oxide, of titanium oxide or of mixtures thereof is suitable as a bonding layer. Herein the layer thickness of the bonding layer which is applied by thermal spraying is preferably between about 10 μm and 150 μm, preferably between about 30 to 100 μm, in particular in a region between about 40 and 70 μm.

Such a thin bonding layer practically has no disadvantageous influence onto the thermal, stresses induced thereby onto the total system, however, offers a particularly good adhesion to the glass ceramic surface, without damaging the latter in the region of the interfaces.

Now onto such a bonding layer directly a ceramic layer which may, preferably, consist of cordierite, of mullite, possibly also of magnesium or mixtures thereof, can be applied by thermal spraying with the necessary layer thickness.

According to an alternative embodiment of the invention between the bonding layer and the insulating layer a thermally sprayed electrically conductive intermediate layer is applied which is, preferably, grounded.

As mentioned before, thereby the requirement with respect to the breakdown resistance of the insulating layer is reduced, if the intermediate layer is grounded and is coupled with a safety switch for switching off in case of breakdown, this resulting to a reduction of breakdown resistance to about 1,500 Volts. Preferably, this intermediate layer consists of an electrically conductive ceramic or of a cermet. An electrically conductive ceramic may for instance be produced by thermal spraying of TiO₂, since during thermal spraying such a high oxygen loss occurs that the material becomes electrically conductive. Thus the volume conductivity at room temperature is between about 10³ Ωcm up to about 5×10² Ωcm at room temperature.

When utilizing a cermet for the production of the electrically conductive intermediate layer, naturally this leads to a considerably higher electrical conductivity, whereby a safe grounding can be reached. By applying a cermet layer onto the bonding layer adhesion problems on the glass ceramic layer are avoided. A suitable cermet comprises a metal matrix of a nickel/chromium/cobalt alloy, wherein carbide particles, such as tungsten carbide or chromium carbide, are dispersed.

Although such a ceramic layer has a coefficient of thermal expansion which is in the region of about 4×10⁻⁶ K⁻¹ to 11×10⁻⁶ K⁻¹, and thus somewhat above aluminum oxide, it is still below the coefficient of expansion of common metals.

Thus advantages result also there from by contrast to the utilization of a prior art metal layer as electrically conductive intermediate layer.

According to a further embodiment of the invention the heat conductor layer is produced by thermal spraying, in particular by laser spraying.

Thereby problems are avoided which result from the production of a heat conductor layer by a screen printing operation as known in the art. Namely, heat conductor layers produced by screen printing operation have a glass fraction in the metallic conductor which is normally above 5%, to allow lower flow temperatures during layer firing. The glass solders in mixed paste that melt at low temperature ensure that a dense closed conductor layer results at firing temperatures between 500 and 850° C. However, the fraction of the glass frit reduces the metallic conductive part. Partial segments of the conductor track, which have an enhanced glass fraction, are regions having a higher resistance so that possibly an overheating or material breakdown may result upon current flow.

These advantages are avoided with a thermally sprayed heat conductor. The necessary structure of the heat conductor herein is produced by a masking process.

Particularly suited is a laser spraying operation, since this is particularly advantageous for producing a track shaped coating.

According to another embodiment of the invention which is also patentable on its own regardless of the utilization of a bonding layer, the cooking plate at its lower surface facing the heat conductor layer comprises an annular recess which extends close to the rim region of the layer sprayed onto the cooking plate.

In this way stresses, which occur in particular in the rim region of the insulating layer sprayed onto the cooking plate, can be considerably reduced. Thus also the risk of delamination in this region is counteracted. Therefore, it is possible to spray layers of a higher thickness even without the utilization of a bonding layer.

According to a further advantageous embodiment of the invention the individual layers occupy areas that diminish toward the heat conductor layer. Also in this way the risk of delamination in the rim region of the layers is counteracted.

It will be understood that the above-mentioned and following features of the invention are not limited to the given combinations, but are applicable in other combinations or taken alone without departing from the scope of the invention.

### BRIEF DESCRIPTION OF THE DRAWINGS

Further features and advantages of the invention will become apparent from the following description of preferred embodiments taken in conjunction with the drawings. In the drawings:

FIG. 1 shows a cross sectional view of a ceramic cooktop according to the invention; and

FIG. 2 shows a cross sectional view of an alternative embodiment of a ceramic cooktop according to the invention.

### DETAILED DESCRIPTION OF THE PREFERRED EMBODIMENTS

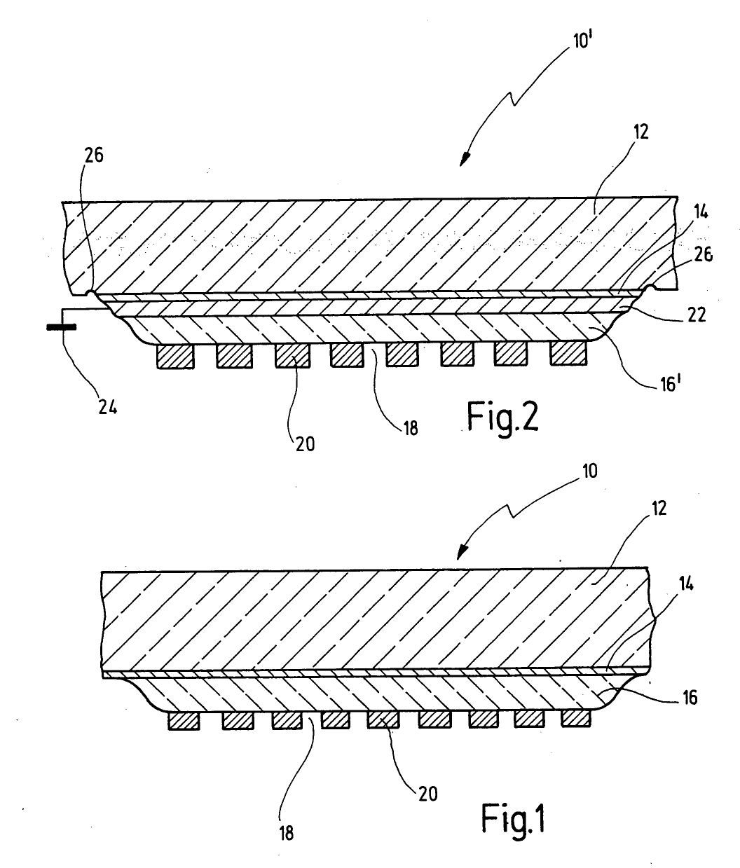

In FIG. 1 a ceramic cooktop according to the invention is designated in total with numeral 10. It comprises a flat cooking plate 12 which, preferably, consists of a glass ceramic, such as CERAN® of Schott.

It will be understood that the representation is merely of exemplary nature and that, in particular, the dimensional relations are not drawn to scale.

The cooking plate serves to support cooking utensils. At the lower surface of the cooking plate 12 a cooking area has been produced at several areas. For household purposes herein typically four or possibly five cooking areas are provided on a ceramic cooktop. However, in FIGS. 1 and 2 only one cooking area is shown respectively.

Onto the lower side of the cooking plate 12, at least onto the areas onto which an insulating layer and a heat conductor layer shall be applied in the following, a bonding layer 14 is applied by thermal spraying, preferably by atmospheric plasma spraying (APS).

Preferably, the application is limited to the regions of the cooking areas, to keep the overall stresses as low as possible.

This bonding layer 14 preferably consists of aluminum oxide, of titanium oxide or of mixtures thereof. In particular, aluminum oxide and mixtures of aluminum oxide and titanium oxide having a small fraction of titanium oxide, e.g. 97 weight percent Al₂O₃ with 3 weight percent TiO₂, offer a particularly good adhesion to the surface of the glass ceramic and also have a very good chemical compatibility. The bonding layer 14 is applied with a layer thickness between about 10 and 150 μm, preferably between about 40 and 70 μm, for instance with about 50 μm. Now onto this bonding layer 14 an insulating layer 16 which preferably consists of cordierite (2MgO.2Al₂O₃) or Mullite (3Al₂O₃.2SiO₂) is applied by thermal spraying with the necessary layer thickness, to guarantee the desired breakdown resistance of 3,750 V at operating temperature of 450° C. In case of cordierite and mullite the layer thickness is preferably about 500 μm, preferably about 200 to 400 μm.

A direct application of the cordierite or mullite layer onto the surface of the glass ceramic would not be possible, since this would lead to damages in the form of microfractures or the like on the glass ceramic surface.

Before thermal spraying the glass ceramic is not pretreated by sandblasting, as normally common, since this would lead to damages on the surface of the cooking plate 12. By contrast, the surface of the cooking plate 12 is merely cleaned, e.g. degreased utilizing acetone.

Subsequently, an electric heat conductor layer 18 is applied by thermal spraying onto the lower surface of the insulating layer 16, wherein the necessary structure of the heat conductor layer 18 is effected by a masking process which by itself is known in the art. E.g. in this way a meander-like wound heat conductor 20 may be produced.

Herein the preferred process for thermal spraying is laser spraying, since thereby in particular a track shape coating may be reached advantageously.

A modification of the ceramic cooktop is shown in FIG. 2 and designated in total with numeral 10′.

The difference with respect to the embodiment of FIG. 1 rests in the fact that the bonding layer 14 is not applied directly onto the insulating layer 16, by contrast initially an electrically conductive intermediate layer 22 is applied, onto which again the insulating layer 16′ is applied.

This electrically conductive intermediate layer 22 is grounded, as indicated in FIG. 2 by the connection with ground 24. In case of defect by breakdown of heat conductor 20 to the cooking plate 12 a safety switch, generally known in the art but not shown here, is triggered.

Again, onto the lower side of the insulating layer 16′ the heat conductor layer 18 is applied as described before.

The electrically conductive intermediate layer 22 preferably consists of a cermet, such as of an alloy based on nickel/chromium/cobalt within which carbide particles, e.g. tungsten carbide and chromium carbide, are dispersed. When compared with common metals, such as cermet by means of the carbide inclusions offers a lower coefficient of thermal expansion, this leading to reduced problems resulting from thermal stresses.

Alternatively, instead of a cermet also an electrically conductive ceramic may be utilized for such an intermediate layer, if a sufficiently high electrical conductivity can be reached. For instance a thermally sprayed layer of TiO₂ could be utilized, since during thermal spraying the TiO₂ loses oxygen in such a way that it becomes electrically conductive. However, the electric conductivity (volume conductivity) of the TiO₂₋ₓ resulting in this way is between 10³ Ωcm to 5×10² Ωcm (at room temperature), this still being considerably lower than the electrical conductivity of metals.

The individual layers 14, 16 according to FIG. 1 or 14, 22, 16′ according to FIG. 2, respectively, occupy surfaces diminishing toward the heat conductor layer 20. Also the individual layers taper gradually, namely, they verge gradually toward the respective layer lying thereunder.

These measures serve to counteract a delamination of the layers in the rim region.

In addition, in FIG. 2 a possibility is shown which allows to partially reduce the somewhat considerable stresses which result in the rim region of the layers.

To this end on the lower side of the cooking plate 12 an annular shaped recess 26 is provided which encloses the rim region of the bonding layer 14 in an annular way. Stresses which are transmitted in the rim region between the cooking plate 12 and the bonding layer 14 may be better absorbed or dispersed, respectively, by this recess.

What is claimed is:

1. A ceramic cooktop comprising:
a cooking plate made of a material selected from the group formed by a glass ceramic and a glass;
a thermally sprayed ceramic bonding layer adhering to a selected surface of said cooking plate, said bonding layer having a thickness of 10 to 150 micrometers;
an electrically conducting intermediate layer located on said ceramic bonding layer and being connected to ground;
an insulating layer located on said intermediate layer; and
an electric heat conductor layer located on said insulating layer.

2. The ceramic cooktop of claim 1, wherein said intermediate layer is made of a material selected from the group formed by TiO₂, a mixture of Al₂O₃ having a portion of at least 50 wt.-% of TiO₂, ZrO₂, a mixture of Al₂O₃ with ZrO₂ having a portion of at least 50 wt.-% of ZrO₂, and a mixture of Al₂O₃ with TiO₂ and ZrO₂ having a portion of at least 50 wt.-% of TiO₂ and ZrO₂.

3. The ceramic cooktop of claim 1, wherein said bonding layer is made of a material selected from the group formed by aluminum oxide, titanium oxide and mixtures thereof.

4. The ceramic cooktop of claim 3, wherein said bonding layer is made of about 97 wt.-% of Al₂O₃ and about 3 wt.-% of TiO₂.

5. The ceramic cooktop of claim 1, wherein said insulating layer consists of a material selected from the group formed by cordierite, mullite, and mixtures therof.

6. The ceramic cooktop of claim 1, wherein said bonding layer has a thickness of about 30 to 100 μm.

7. The ceramic cooktop of claim 1, wherein said bonding layer has a thickness of about 40 to 70 μm.

8. A ceramic cooktop comprising:
a cooking plate made of a material selected from the group formed by a glass ceramic and a glass;
a thermally sprayed ceramic bonding layer adhering to a selected surface of said cooking plate;
an electrically conducting intermediate layer located on said ceramic bonding layer and being connected to ground;
an insulating layer located on said intermediate layer; and
an electric heat conductor layer located on said insulating layer.

9. A ceramic cooktop comprising:
a cooking plate made of a material selected from the group formed by a glass ceramic and a glass;
a thermally sprayed ceramic bonding layer adhering to a selected surface of said cooking plate;
an insulating layer located on said intermediate layer; and
an electric heat conductor layer located on said insulating layer.

10. The ceramic cooktop of claim 8, wherein said bonding layer has a thickness of about 10 to 150 μm.

11. The ceramic cooktop of claim 8, wherein said bonding layer has a thickness of about 30 to 100 μm.

12. The ceramic cooktop of claim 8, wherein said bonding layer has a thickness of about 40 to 70 μm.

13. The ceramic cooktop of claim 8, further comprising an electrically conductive intermediate layer applied between said bonding layer and said insulating layer.

14. The ceramic cooktop of claim 13, wherein said electrically conductive intermediate layer is configured as an oxide layer that is rendered electrically conductive by oxygen loss during thermal spraying.

15. The ceramic cooktop of claim 13, wherein said intermediate layer consists of a cermet material having a metal matrix comprising at least one component selected from the group formed by nickel, cobalt and chromium.

16. A ceramic cooktop comprising:
a cooking plate made of a material selected from the group formed by a glass ceramic and a glass;
an electric heat conductor layer;
an insulating layer arranged between said cooking plate and said heat conductor layer; and
an annular groove provided on a surface of said cooking plate facing said layers, said annular groove surrounding a rim area of said insulating layer.
